(19) United States
(12) Patent Application Publication
(10) Pub. No.: US 2024/0337363 A1
(43) Pub. Date: Oct. 10, 2024

(54) ILLUMINATED RADOME COVER

(71) Applicant: Magna Exteriors GmbH, Sailauf (DE)

(72) Inventors: Thomas PAULE, Glattbach (DE); Miguel BENITEZ, Mainhausen (DE)

(21) Appl. No.: 18/623,227

(22) Filed: Apr. 1, 2024

(30) Foreign Application Priority Data
Apr. 6, 2023 (DE) 102023203211.2

(51) Int. Cl. F21S 43/241; B60Q 1/00; B60R 13/04; F21S 43/247; F21S 45/60; G01S 7/02; H01Q 1/42

(52) U.S. Cl. CPC F21S 43/241; B60Q 1/0011; B60Q 1/0023; B60R 13/04; F21S 43/247; F21S 45/60; G01S 7/027; H01Q 1/42

(57) ABSTRACT

A radome cover in a vehicle, which has a decorative film, which is over-injected on an inner surface using a layer made of a first plastic to produce a light guiding layer and is back-injected on an outer surface using a cover layer. The radome cover further includes a reflection ring having at least one metallically reflective surface that is introduced on the inner surface on the decorative film. The reflection ring having a ring base having an inclined plane which reflects vertically incident light into the light guiding layer.

### CROSS-REFERENCE TO RELATED APPLICATIONS

This application claims priority to German Application No. DE 102023203211.2 filed Apr. 6, 2023. The entire disclosure of the above application is incorporated herein by reference.

### FIELD OF THE INVENTION

The invention relates to an illuminated radome cover for an opening of a vehicle and a method for producing a radome cover.

### BACKGROUND OF THE INVENTION

This section provides information related to the present disclosure which is not necessarily prior art.

Functional elements, such as sensors or the like, are generally to be arranged in a body or outer wall of a vehicle. Furthermore, covering or closing such openings for the functional elements using suitable cover elements can be provided for protection of these functional elements and for aesthetic reasons.

A radiation-transmissive plastic cover is described in document DE 10 2004 050 501 B3. This is provided for openings in vehicle bodies, in particular a radome transmissive to electromagnetic beams such as radar beams, which has a body made of transparent plastic having an outer surface. A colour contrasting pattern of a radiator panel or a company emblem is represented by the outer surface. This company emblem is attached to a rear surface of the body opposite to the outer surface. The rear side of the transparent body formed by injection moulding is back-injected over the surface, in particular over the entire surface, but omitting the area provided for the pattern, using a plastic compound. In addition, a region of the pattern is fixedly connected after its application to a plastic body by injecting a plastic material with the body formed by the plastic compound.

DE 10 2015 220 346 A relates to a radome having an essentially planar front plate, which is made translucent on the front side and which is provided on the rear side with a light-opaque layer, wherein at least one opening is formed as a light passage in the light-opaque layer, having a reflective area of the planar front plate, wherein the reflective area is arranged adjacent to the opening, having at least one essentially planar light guide, which is arranged on the rear side of the light-opaque layer, and having at least one lighting element, which is coupled to the light guide such that light enters the light guide and such that the light propagates through the at least one light guide, wherein at least one diffuser element is arranged on the at least one light guide, which is arranged such that the light propagating through the at least one light guide enters the diffuser element, propagates through the diffuser element, and exits from the diffuser element and enters the at least one light passage in the translucent front plate and is possibly reflected on the reflective area, so that it exits on the front side from the front plate, wherein the diffuser element has a modulated extension.

A radome is known from DE 10 2015 004 204 A1, wherein the rear side is divided by the contours of moulded-in surface structures into multiple separate regions. A rear side divided in this way has a depression in each of the regions. Each of the contours is separated by a coupling structure from the respective depression extending along the contour. A planar light guide is laid in the depression.

DE 10 2016 007 119 A1 comprises a radome having a front side, a rear side, and at least one coupling structure formed in the rear side for coupling in light. At least one light guide for transmitting the coupled-in light is arranged on the rear side, wherein at least one light exit region of the at least one light guide is made translucent and wherein the light exit region is completely covered at least in the direction of the light exit by an optically non-active component.

EP 2 072 334 A1 discloses an assembly for the illuminated display of a logo in a motor vehicle having a carrier and at least one light source, which is arranged behind or adjacent to the carrier. A transparent plastic extrusion coating is arranged over the logo. The light of the light source is coupled through laterally past the logo and/or between logo structures into the transparent plastic extrusion coating. The transparent plastic extrusion coating has light-deflecting fibres.

WO 2021/180 168 A1 discloses a vehicle light having an outer lens, comprising: a first lens section and a reflective section, wherein the reflective section is arranged on at least one side of the first lens section in close contact with the first lens section and is capable of reflecting a light beam entering the first lens section so that the light beam propagates in the first lens section in the inside.

### SUMMARY OF THE INVENTION

This section provides a general summary of the disclosure, and is not a comprehensive disclosure of its full scope or all of its features.

It is the object of the invention to provide an illuminated radome cover for an opening of a vehicle which can be produced easily and can be scaled in a simple manner.

The object is achieved by a radome cover in a vehicle, which has a decorative film, which is over-injected on an inner surface using a layer made of a first plastic to produce a light guiding layer and is back-injected on an outer surface using a cover layer, wherein a reflection ring having at least one metallically reflective surface is introduced on the inner surface on the decorative film, wherein the reflection ring has a ring base having an inclined plane, wherein the light propagates along the height of the light guiding elements by total reflection and is coupled by the inclined plane of the reflection ring into the light guiding layer.

The light guiding layer is covered by a reflective foil which reflects the light into the light guiding layer.

The light guiding layer has light guiding elements directly connected to the reflection ring and which rise at least to the height of the reflection ring.

The light guiding elements consist either of a light guiding ring having an outer diameter which corresponds to the inner diameter of the reflection ring, or of light guiding domes. The light guiding elements guide light from LEDs, which are mounted on a circuit board that is installed between the radome cover and the radar sensor.

The decorative film comprises a heating element or is used as a carrier for a heating element.

The object is also achieved by a method for producing a radome cover as described, comprising the following steps:

laying the decorative film in the cavity of a mould part, laying the reflection ring in the cavity of the mould part or in the cavity of a revolving mould, laying the reflective film in the cavity of the revolving mould, injection moulding the light guiding layer with the light guiding elements, rotating the revolving mould around its longitudinal axis by 180°, opening it, injection moulding the cover layer on the outside of the decorative film.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The figures will be described coherently and comprehensively, identical reference signs designate identical components.

FIGS. 1 and 2 show a schematic representation of a method for producing a radome cover in a revolving mould.

FIG. 3 shows a schematic representation of an embodiment of the radome cover according to the invention.

FIG. 4 shows a top view of a radome cover.

FIG. 5 shows an alternative embodiment.

### DESCRIPTION OF THE INVENTION

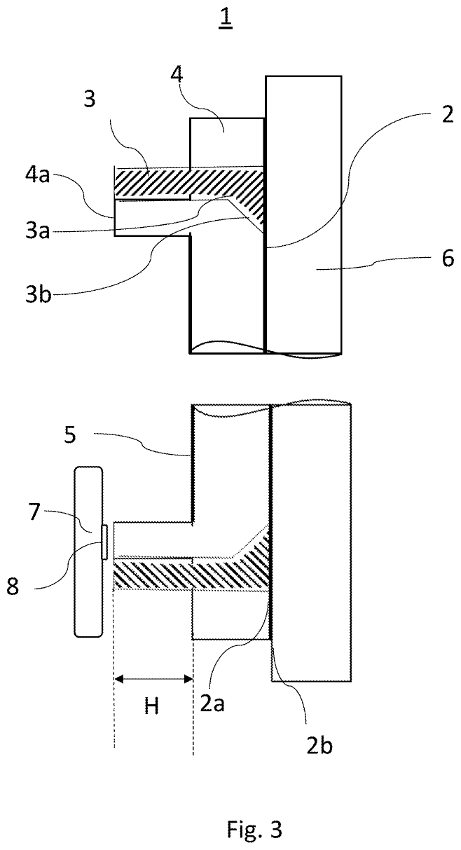

FIG. 3 shows a decorative film 2, which can be metal coated and/or is formed from two plastic layers, between which a metallic layer is at least partially embedded.

In one embodiment, one of the plastic layers is the carrier of heating lines. These are either vapour deposited or printed on the film. The heating lines are applied in a meandering shape here, wherein the distances between the individual lines are selected so that the radar signal is not interfered with.

Alternatively, one of the plastic layers is used as a carrier for a heating element, which is applied to a separate film. This heating film is connected to the decorative film 2, in the simplest case adhesively bonded. Alternatively to the use of heating lines, a use of heating surfaces as a surface heater is conceivable.

The inner surface 2a of this decorative film 2 is printed with ink at some points during production so that a pattern is provided overall on the inner surface. Due to this printing with, for example, black ink, the visible internal surface 2a is accordingly made at least partially coloured.

The printing is viewed here in one embodiment solely as creative. However, a heating element can also be printed on additionally or as the only printing.

The decorative film 2 having the applied ink and/or the heating element can be subjected to a deep drawing process. The decorative film 2 is deformed by this deep drawing process such that it now has a profile or relief in cross section. For radome covers 1 having decorative films 2 which are strongly formed in the deep drawing process, the printing with the heating element is possibly to be arranged after the deep drawing process. Then the deep drawing of the decorative film 2 takes place first and the printing only after the three-dimensional formation.

A reflection ring 3, which terminates flush with the decorative film with its ring base 3a, is attached to the inner surface 2a of the decorative film 2. The reflection ring 3 has at least one metal-coated surface and consists either of a plastic ring which is chrome plated or of a reflective metal.

The ring base 3a terminates at the ring interior with an inclined plane 3b, wherein this inclined plane 3b has an angle of 45° to the vertical. In one exemplary embodiment, the reflection ring 3 has a height of 8 to 10 mm. A glass-clear plastic is injection moulded directly onto the reflection ring 3, which forms a light guiding ring 4b clinging to the inner wall of the reflection ring 3. Moreover, the inner surface 2a is also provided with glass-clear polymer to create a light guiding layer 4.

A reflective film 5 covers the light guiding layer 4 in the inside of the ring. This reflective film 5 reflects visible light but is transparent to radar wavelengths.

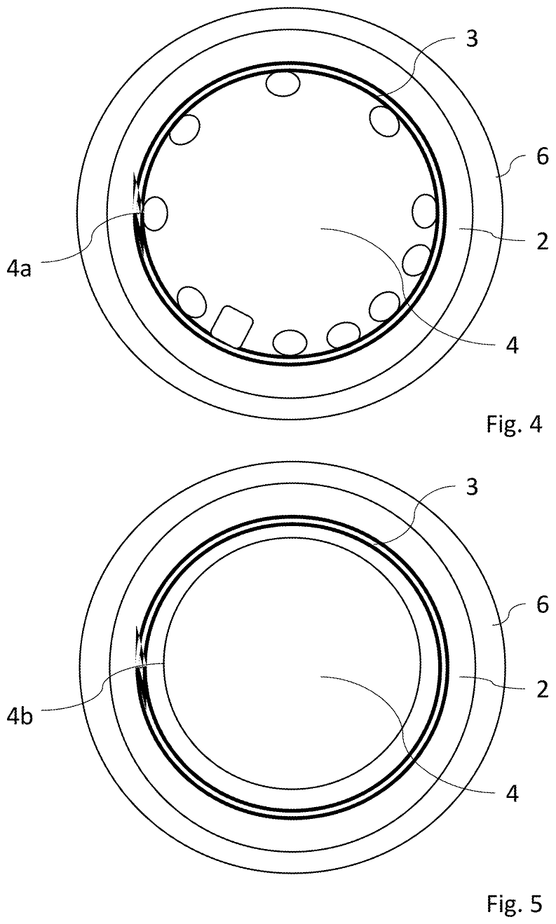

FIG. 5 shows the light guiding ring 4b in a top view of the radome cover 1. Alternatively thereto, as shown in FIG. 4, light guiding domes 4a can also be injection moulded, which can be round, oval, or polygonal in cross section. Light guiding domes 4a and light guiding ring 4b as light guiding elements end flush at the height H with the reflection ring 3.

The height H by which the reflection ring 3 and the light guiding element protrudes above the light guiding layer 4 is, for example, 2-3 mm.

It is thus easier to install a circuit board 7 having LEDs 8, as indicated by the component 7.

LEDs attached in a circle are installed on the circuit board 7, which either each feed light into a light guiding dome 4a or all feed light into the light guiding ring 4b.

The light propagates by total reflection along the height of the light guiding elements and is coupled by the inclined plane 3b of the reflection ring 3 into the light guiding layer 4.

The light guiding layer 4 is covered by a reflective film, so that total reflection of the light propagating in the light guiding layer 4 takes place here. The light is partially reflected on the decorative film and partially decoupled. A transparent layer is applied as a cover layer 6 on the outer surface 2b of the decorative film 2.

The radome cover 1 can be formed as an emblem for the vehicle, as is formed prominently in the centre of a radiator grill, for example. Polycarbonate (PC) can be provided as a plastic for injection moulding or for over-injecting and/or back-injecting the film. Because polycarbonate is provided in particular as the plastic to be used for the two layers, thus the layer on the upper side and the cover layer, and, for example, polycarbonate is provided for the film, a good bond is provided between the individual layers and the film. In particular the first plastic provided for over-injecting the front side of the film is at least partially optically transparent here, so that a pattern which is represented by the metal-coated film is visible to the outside.

Because the plastic to be injected above and below on the decorative film 2 and the plastic layers of the decorative film 2 are formed from polycarbonate or are at least materially based thereon, overall a substantially homogeneous and integral radome cover is provided.

The metallic layer of the film has a thickness of a few micrometres, approximately in the order of magnitude of 2 μm. The thickness of the metallic layer is selected so that it is transparent to electromagnetic waves and creates a metallic appearance at the same time.

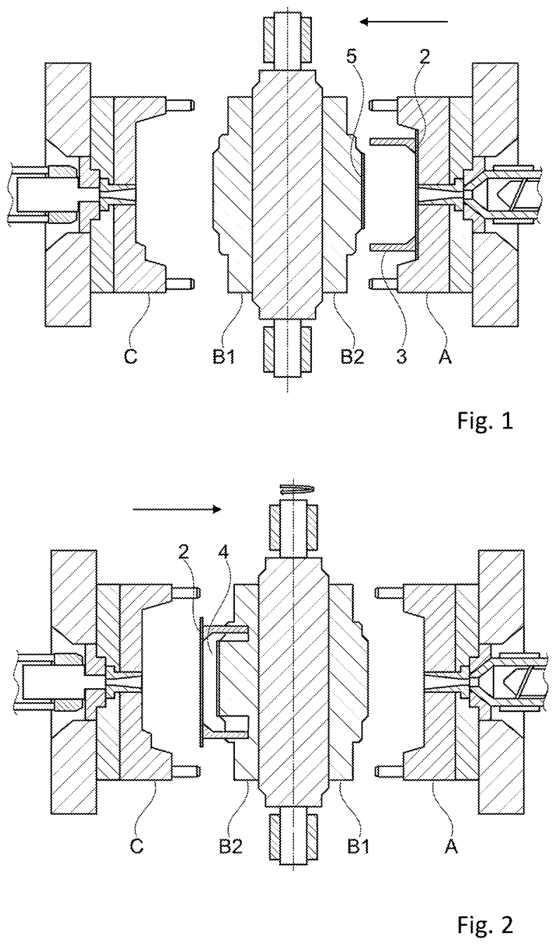

FIGS. 1 and 2 schematically show a simplified production method. For this purpose, a revolving mould is used for the plastic injection moulding. The mould consists at least of a mould part A having a cavity, a revolving mould having the cavities B1 and B2, and a mould part C having a cavity.

In the first step, the first injection moulding procedure is prepared in that the decorative film is laid in the cavity of the mould A. In this example, the decorative film 2 is flat. After the decorative film 2 has been laid, the reflection ring 3 is inserted into the cavity of the mould part A or also into the cavity B2. A film, the reflective film 5, is also laid in the cavity B2 of the revolving mould. After the mould is closed by moving the mould part A in the direction of the arrow, the light guiding layer 4 having the light guiding elements is injected. The revolving mould is rotated by 180° around its longitudinal axis.

The mould is then opened again, wherein it is ensured that the freshly injected component remains in the cavity B2.

The mould C moves in the direction of the arrow toward the revolving mould and is closed. The cover layer 6 is then injected on the outside 2b of the decorative film 2.

What is claimed is:

1. A radome cover in a vehicle, which has a decorative film, which is over-injected on an inner surface using a layer made of a first plastic to produce a light guiding layer and is back-injected on an outer surface using a cover layer, wherein a reflection ring having at least one metallically reflective surface is introduced on the inner surface on the decorative film, wherein the reflection ring has a ring base having an inclined plane, wherein the light propagates along the height of the light guiding elements by total reflection and is coupled by the inclined plane of the reflection ring into the light guiding layer.

2. The radome cover according to claim 1, wherein the light guiding layer is covered using a reflective film which reflects the visible light into the light guiding layer.

3. The radome cover according to claim 1, wherein the light guiding layer has light guiding elements directly connected to the reflection ring, which rise at least up to the height of the reflection ring.

4. The radome cover according to claim 3, wherein the light guiding elements either are a light guiding ring having an external diameter which corresponds to the internal diameter of the reflection ring or consist of light guiding domes.

5. The radome cover according to claim 3, wherein the light guiding elements guide light from LEDs, which are mounted on a circuit board that is installed between the radome cover and a radar sensor.

6. The radome cover according to claim 1, wherein the decorative film comprises a heating element or is used as a carrier for a heating element.

7. A method for producing a radome cover according to claim 2 comprising the following steps:
laying the decorative film in the cavity of a mould part,
laying the reflection ring in the cavity of the mould part or in the cavity of a revolving mould,
laying the reflective film in the cavity of the revolving mould,
injection moulding the light guiding layer having the light guiding elements, rotating the revolving mould around its longitudinal axis by 180°, opening it, and
injection moulding the cover layer on the outer surface of the decorative film.
